(19) United States
(12) Patent Application Publication
(10) Pub. No.: US 2012/0189303 A1
(43) Pub. Date: Jul. 26, 2012

(54) OPTICAL TRANSPORT MULTIPLEXING CLIENT TRAFFIC ONTO PARALLEL LINE SYSTEM PATHS

(76) Inventors: Peter J. Winzer, Aberdeen, NJ (US); Andrew Roman Chraplyvy, Matawan, NJ (US); Robert William Tkach, Little Silver, NJ (US)

(21) Appl. No.: 13/012,613

(22) Filed: Jan. 24, 2011

(51) Int. Cl. H04J 14/00

(52) U.S. Cl. 398/43

(57) ABSTRACT

An optical line card system includes one or more input interfaces for receiving information, a line interface comprising a plurality of line transponders, and a multiplexer for multiplexing output of the one or more input interfaces onto the plurality of line transponders. The one or more input interfaces have an aggregate information rate R_{C}. The plurality of line transponders have an aggregate information rate R_{L} that is less than or approximately equal to the aggregate information rate R_{C} of the one or more of client interfaces. Each of the line transponders employs a modulation format with a spectral efficiency that enables transmission with at most one opto-electronic regeneration point per link to an end point for electronic routing or switching. Each of the plurality of line transponders is configured to insert output on a respective one of a plurality of orthogonally parallel transmission paths.

### FIELD OF THE INVENTION

The subject matter of this application relates to optical transmission equipment and, more specifically but not exclusively to the equipment that enables data transmission using spatial multiplexing.

### BACKGROUND INFORMATION

This section introduces aspects that may help facilitate a better understanding of the disclosed subject matter. Accordingly, the statements of this section are to be read in this light and are not to be understood as admissions about what is in the prior art or what is not in the prior art.

In order to satisfy the unabated exponential growth of data network traffic, optical communications research and development have increased the capacities of wavelength-division multiplexed (WDM) transport systems by improving spectral efficiency through techniques such as higher-order modulation and polarization-division multiplexing (PDM).

FIG. 1 shows combinations of experimentally achieved PDM spectral efficiencies and transmission distances reported at the post-deadline sessions of the Optical Fiber Communications Conference (OFC) and the European Conference on Optical Communication (ECOC).

In FIG. 1, circles (currently upper-bounded by the dotted line) indicate WDM transmission experiments. Squares (together with the dashed fitting line) represent narrow-band filtered single-channel experiments that could potentially achieve the indicated WDM spectral efficiencies, assuming negligible WDM guard bands and an insignificant impact of inter-channel nonlinearities. On the commercial side, WDM systems at PDM spectral efficiencies of 2 b/s/Hz with a reach of approximately 1,500 km are being deployed.

As reported by R.-J. Essiambre et al., “Capacity limits of optical fiber networks,” J. Lightwave Technol. 28(4), 662-701 (2010), system dependent upper bounds on spectral efficiency and transmission distance may be arrived at by calculating the Shannon limit of the inherently nonlinear optical fiber channel. The Shannon limit on standard single-mode fiber (SSMF) using distributed optical amplification, scaled to include PDM, is shown by the solid line in FIG. 1. Note that on a logarithmic x-scale, all limiting curves appear as straight lines.

As shown by FIG. 1, increasing capacity by increasing spectral efficiency comes at the cost of reduced system reach. One existing solution to scale optical transport capacity therefore uses multiple opto-electronic regeneration points (OEOs) to bridge a given link. Another existing solution, shown in the optical line system architecture of FIG. 2, deploys multiple independent and autonomously operating line systems on parallel optical fiber strands. As shown in FIG. 2, client interfaces 212 of a first independent line system 210 receive input of aggregate bit rate R_{C} from clients. The first independent line system multiplexer (or “line card”) 214 multiplexes the input onto a line transponder of a line interface 216 for output to an optical cable 220. Likewise, client interfaces 252 of a second independent line system 250 receive input of aggregate rate R_{C} from clients. The second independent line system multiplexer 254 multiplexes the input onto a line transponder of a line interface 256 for output to an optical cable 220 with at least two parallel fiber strands. The first and second line systems independently map each set of clients with aggregate rate R_{C} onto their line interface, with the aggregate rate R_{L} of the line being essentially equal to the rate R_{C} of a line interface (i.e., R_{L}=R_{C}).

Another known solution is “1+N protection”, where a communication system uses N+1 line cards that are controlled by a common control framework and switch. The first line card transmits a first (high-priority) client signal of rate R_{C} on its line interface of rate R_{L} and reserves the remaining N line interfaces for transmitting that same client information in case of a system failure or fiber cut.

### SUMMARY

The following presents a simplified summary of the disclosed subject matter in order to provide an understanding of some aspects of the disclosed subject matter. This summary is not an exhaustive overview of the disclosed subject matter and is not intended to identify key or critical elements of the disclosed subject matter not to delineate the scope of the disclosed subject matter. Its sole purpose is to present some concepts in a simplified form as a prelude to the more detailed description that is discussed later.

Increasing capacity by increasing spectral efficiency comes at the cost of reduced system reach. To address the issue of system reach with increased spectral efficiency, existing optical line systems employ a variety of methods. For example, spectral efficiency is increased at the cost of reach, so that multiple opto-electronic regeneration points (OEOs) may be utilized to bridge a given link. However, neither energy consumption nor cost of such existing systems scale in a sustainable fashion as a consequence.

Another existing system deploys multiple independent line systems on parallel optical fiber strands. However, these independent parallel line systems operate independently with their own individual system control and management system and operational support functions, thus increasing cost, size, etc. Another existing system uses N+1 line cards that are controlled by a common control framework and switch to provide “1+N protection.” However, in such existing “1+N protection” systems, the spatially diverse paths that provide protection are chosen to be as geographically diverse as possible and will generally not use the same transmission cable. Further, while these systems may be configured to route low-priority traffic from N low-priority client interfaces on the N protection paths, this is accomplished with the understanding that this traffic will be lost in case of a system failure necessitating use of a protection path/s for the high-priority traffic. Thus, such systems do not reliably increase capacity and resilience for all traffic but merely increase resilience for high-priority traffic. Accordingly, since the WDM capacities of traditional transport systems are reaching their limits, a new class of systems that scales significantly beyond the capabilities of state of the art transport systems and their projected evolution is desirable.

One or more embodiments herein disclosed use parallel transmission paths to transport client traffic over optical cables in the transport network. In particular, a set of client interfaces with an aggregate information rate Rc is multiplexed onto a set of line transponders integrated into a line interface of aggregate information rate R_{L} which is less than or approximately equal to R_{C}. In this manner, the information of N client interfaces is multiplexed into K line interfaces that operate on spatially diverse transmission paths (typically within the same fiber cable or the same or close-by cable conduit) but are still part of the same line system, with a single management and control system and a single set of operational support functions.

In one embodiment, an optical line card system includes one or more input interfaces for receiving information, the one or more input interfaces having an aggregate information rate R_{C}; a line interface comprising a plurality of line transponders having an aggregate information rate R_{L} that is less than or approximately equal to the aggregate information rate R_{C} of the one or more of client interfaces; and a multiplexer for multiplexing output of the one or more input interfaces onto the plurality of line transponders. Each of the line transponders employs a modulation format with a spectral efficiency that enables transmission with at most one opto-electronic regeneration point per link to an end point for electronic routing or switching and each of the plurality of line transponders is configured to insert output on a respective one of a plurality of orthogonally parallel transmission paths.

In one embodiment, the plurality of orthogonally parallel transmission paths are spatially orthogonal. The plurality of orthogonally parallel transmission paths may be spatially separated fiber strands, cores of a multi-core fiber, or modes of a multi-mode fiber. In one embodiment, the plurality of orthogonally parallel transmission paths are orthogonal by wavelength. In another embodiment, the plurality of orthogonally parallel transmission paths are orthogonal by optical amplification band. The plurality of line transponders may be configured to transmit on a first wavelength set of one or more wavelengths. The line transponders may be integrated.

In another embodiment, an optical line system includes a first line card system as described above and an optical link having the plurality of orthogonally parallel transmission paths, the first line card system connected to the optical link, the optical link for connection to an end point for electronic routing or switching, the optical link including at most one opto-electronic regeneration point. The optical line system may also include a second line card system as described above with the first line card configured to transmit on a first wavelength set having one or more wavelengths; and the second line card system configured to transmit on a second wavelength set having one or more wavelengths, the one or more wavelengths of the second wavelength set differing from the one or more wavelengths of the first wavelength set.

In one embodiment, the optical line system may also include an end point for electronic routing or switching, a router, a switch, or a receiver. The plurality of orthogonally parallel transmission paths may be spatially orthogonal or orthogonal by wavelength or orthogonal by optical amplification band. Thus, in various embodiments, the plurality of orthogonally parallel transmission paths may be spatially separated fiber strands, cores of a multi-core fiber, modes of a multi-mode fiber, or optical amplification bands.

In another embodiment, a method includes multiplexing by a first line card system first input from a first set of one or more input interfaces onto a first plurality of line transponders, the input having an first aggregate rate R_{C1}; modulating by the first plurality of line transponders the first input to generate first modulated information, the modulating of the first plurality of line transponders utilizing a first modulation format with a spectral efficiency that enables transmission with at most one opto-electronic regeneration point per link to a corresponding end point for electronic routing or switching; and outputting the first modulated information from the first plurality of line transponders to a first plurality of orthogonally parallel transmission paths, the first modulated information that is output having a first aggregate rate R_{L1}, wherein the first aggregate rate R_{C1} is less than or approximately equal to the first aggregate rate R_{L1}.

In one embodiment, the method includes regenerating the first modulated information at a single opto-electronic regeneration point between at least one of the first plurality of line transponders and the corresponding end point. In one embodiment, the method includes providing the first modulated information to the corresponding end point with at most one regeneration of the first modulated information. Thus, there may be no regeneration of the first modulated information between at least one of the first plurality of line transponders and the corresponding end point. Each of the first plurality of line transponders may modulate the first input onto a first wavelength set of at least one first wavelength. The plurality of orthogonally parallel transmission paths may be spatially orthogonal or orthogonal by wavelength or orthogonal by optical amplification band. In various embodiments, the plurality of orthogonally parallel transmission paths may be spatially separated fiber strands, cores of a multi-core fiber, modes of a multi-mode fiber, or optical amplification bands.

In one embodiment, the method includes multiplexing by a second line card system second input from a second set of one or more client interfaces onto a second plurality of line transponders, the second input having an second aggregate rate R_{C2}; modulating by the second plurality of line transponders the second input to generate second modulated information, the modulating of the second plurality of line transponders utilizing a second modulation format with a spectral efficiency that enables transmission with at most one opto-electronic regeneration point per link to a corresponding receiver; and outputting the second modulated information from the second plurality of line transponders to a second plurality of orthogonally parallel transmission paths, the second modulated information output having a second aggregate rate R_{L2}, wherein the second aggregate rate R_{C2} is less than or approximately equal to the second aggregate rate R_{L2}; with the second modulated information on a second wavelength set of at least one second wavelength and the first modulated information on a first wavelength set of at least one first wavelength, the at least one first wavelengths differing from the at least one second wavelengths.

In another embodiment, a method of scaling optical system throughput includes determining, for example by a processor, one or more modulation formats that permit a desired system reach at a desired aggregate system capacity between transmission endpoints utilizing at most a single OEO between the transmission endpoints; and providing a line card as claimed in claim 1 wherein at least one of the plurality of transponders is operable to modulate according at least one of the one or more modulation formats.

In one embodiment, determining one or more modulation formats includes determining a maximum spectral efficiency (SE) that allows the desired system reach between transmission endpoints utilizing at most a single opto-electronic regeneration; determining a first modulation format with first SE less than or approximately equal to the maximum SE; determining whether the first modulation format allows the desired system reach with at most a single opto-electronic regeneration; and when the first modulation format allows the desired transmission distance with at most a single opto-electronic regeneration, determining a number of orthogonally parallel paths to be employed by the line card. The number of orthogonally parallel paths may be based on the desired system reach, the desired aggregate system capacity, and an amplification bandwidth.

### BRIEF DESCRIPTION OF THE DRAWINGS

Other aspects, features and benefits of various embodiments will become more fully apparent, by way of example, from the following detailed description and the accompanying drawings, in which:

FIG. 1 shows combinations of experimentally achieved PDM spectral efficiencies and transmission distances reported at the post-deadline sessions of the Optical Fiber Communications Conference (OFC) and the European Conference on Optical Communication (ECOC);

FIG. 2 illustrates existing optical line system architectures;

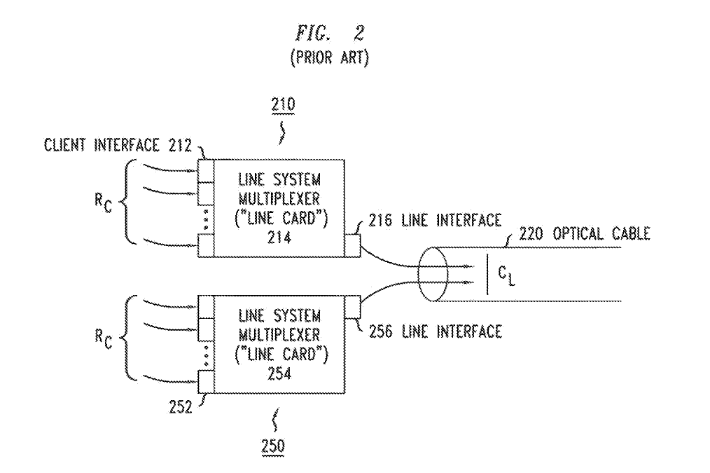

FIG. 3 illustrates and an example line card and an example optical line system according to one embodiment; and

FIG. 4 illustrates a method of scaling optical system throughput according to one embodiment.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. Moreover, a first element and second element may be implemented by a single element able to provide the necessary functionality of separate first and second elements.

As used herein the description, the term “and” is used in both the conjunctive and disjunctive sense and includes any and all combinations of one or more of the associated listed items. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

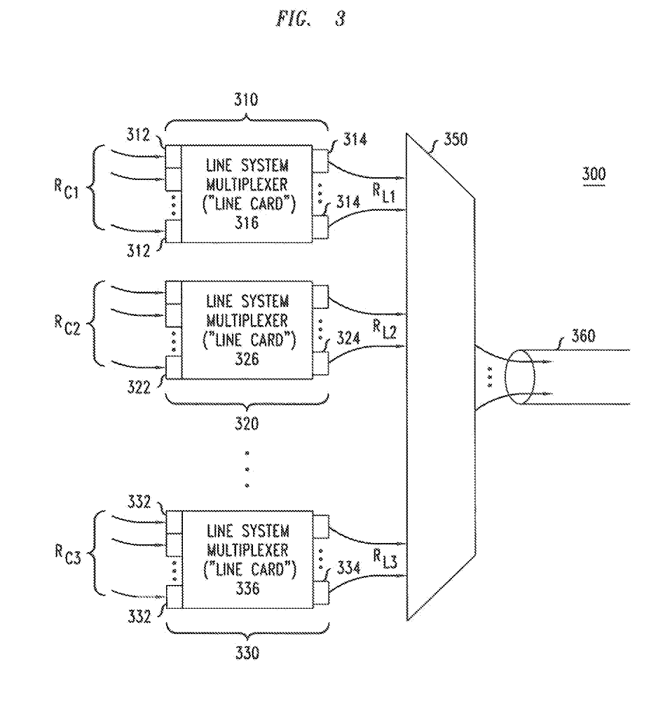

One or more embodiments herein disclosed use parallel transmission paths to transport traffic over optical cables in the transport network FIG. 3 illustrates and an example line card and an example optical line system according to one embodiment. As shown in FIG. 3, the optical line system 300 may include one or more line cards 310, 320, 330, etc.

At a first line card 310, a set of client interfaces 312 with an aggregate information rate R_{c1} is multiplexed onto a set of line transponders 314 integrated into a line interface of aggregate information rate R_{L1} which is less than or approximately equal to R_{C1}. In this manner, the information of N client interfaces is multiplexed into K line interfaces that operate on spatially diverse transmission paths but are still part of the same line system, with a single management and control system and a single set of operational support functions.

The first optical line card 310 includes one or more input interfaces 312 for receiving information, a line interface comprising a plurality of line transponders 314, and a multiplexer 316 for multiplexing output of the one or more input interfaces onto the plurality of line transponders. The one or more input interfaces 312 have an aggregate information rate R_{C1}. The aggregate information rate may be an aggregate net rate to account for the absence of header information. The line card may receive the information input from one or more clients. The multiplexer 316 may be an inverse multiplexer, depending on the number of client interfaces (N) and the number of line interfaces (K).

The line interface and its plurality of line transponders 314 have an aggregate information rate R_{L1} that is less than or approximately equal to the aggregate information rate R_{C1} of the one or more of client interfaces. The aggregate information rate R_{L1} of the line transponders may be less than R_{C1} so as to account for receipt of dummy data.

Each of the line transponders 314 employs a modulation format with a spectral efficiency that enables transmission with at most one opto-electronic regeneration point per link (e.g. an optical cable or a sequence of optical cables) to an end point for electronic routing or switching. Thus, a link is an “end-to-end data path between two points in a network that perform electronic routing or switching functionality.

Each of the plurality of line transponders 314 is configured to insert output on a respective one of a plurality of orthogonally parallel transmission paths. For example, the plurality of orthogonally parallel transmission paths may be in an optical cable 360.

The plurality of orthogonally parallel transmission paths may be spatially orthogonal by wavelength or orthogonal by amplification band. Thus in various embodiments, the plurality of orthogonally parallel transmission paths may be spatially separated fiber strands, cores of a multi-core fiber, or modes of a multi-mode fiber.

Each of the plurality of line transponders 314 of the first line card 310 may be configured to transmit on a first wavelength set. The first wavelength set may include one or more first wavelengths. The line transponders of the line interface of the first line card may be integrated.

A second optical line card system 320 may include N input interfaces for receiving information, the N input interfaces having an aggregate information rate R_{C2} wherein N is an integer greater than or equal to 1. The second optical line card may also include a line interface comprising K line transponders 324 wherein K is an integer greater than 1, and a multiplexer 326 for multiplexing output of the N input interfaces onto the K line transponders, the K line transponders having an aggregate information rate R_{L2} that is less than or approximately equal to the aggregate information rate R_{C2} of the N interfaces. Depending on the values of N and K, the multiplexer may be an inverse multiplexer. Each of the K line transponders 324 employs a modulation format with a spectral efficiency that enables transmission with at most one opto-electronic regeneration point per link to an end point for electronic routing or switching and is configured to insert output on a respective one of a plurality of orthogonally parallel transmission paths.

In similar fashion to the first line card system above, a third optical line card system 330 may include one or more input interfaces 332 for receiving information, a line interface comprising a plurality of line transponders 334, and a multiplexer 336 for multiplexing output of its one or more input interfaces onto its plurality of line transponders. The one or more input interfaces 332 have an aggregate information rate R_{C2}. The third line interface and its plurality of line transponders 334 have an aggregate information rate R_{L2} that is less than or approximately equal to the aggregate information rate R_{C2} of the one or more of client interfaces.

Each of the line transponders 334 employs a modulation format with a spectral efficiency that enables transmission with at most one opto-electronic regeneration point per link (e.g. an optical cable or a sequence of optical cables 360) to an end point for electronic routing or switching. That is; the optical link connects to an end point (not shown) for electronic routing or switching and the optical link includes at most one opto-electronic regeneration point.

Each of the plurality of line transponders 334 is configured to insert output on a respective one of a plurality of orthogonally parallel transmission paths such as those in optical cable 360. The plurality of orthogonally parallel transmission paths may be spatially orthogonal, orthogonal by wavelength or orthogonal by amplification band.

Each of the plurality of line transponders 334 of the third line card 330 may be configured to transmit on a third wavelength set whose wavelengths differs from the wavelengths of the first wavelength set employed by the first line card. Again, line transponders of a line interface may be integrated.

When a plurality of line cards systems are utilized in the optical transport system, a multiplexer 350 may receive output from the line card systems, multiplex the received outputs for the line card systems and insert an the multiplexed information onto the optical cable 360. Thus an example system may include a first line card system and/or second line card system, etc., as described above and an optical link having the plurality of orthogonally parallel transmission paths, the one or more line card systems connected to a corresponding optical link, the corresponding optical link for connection to an end point for electronic routing or switching, the corresponding optical link including at most one opto-electronic regeneration point. Each line card system may be configured to transmit on a unique wavelength or set of wavelengths. For example, a first line card system may be configured to transmit on a first wavelength set and a second line card system may be configured to transmit on a second wavelength set, the constituent wavelengths of the second wavelength set differing from the constituent wavelengths of first wavelength set.

The transponders may use intensity-modulated optical modulation formats (such as on/off keying), or more generally polarization-multiplexed complex-valued optical modulation formats (such as polarization-multiplexed quadrature phase shift keying or quadrature amplitude modulation). For the case where spatially diverse transmission paths are formed by multi-mode or multi-core waveguides, methods for transmitting and receiving information in a mode-selective way are disclosed in U.S. Patent Application Publication No. 2010/0329670, by R. Essiambre et al, published Dec. 30, 2010, and entitled “Receiver for Optical Transverse-Mode-Multiplexed Signals,” and U.S. Patent Application Publication No. 2010/0329671, by R. Essiambre et al, published Dec. 30, 2010, and entitled “Transverse-Mode-Multiplexing For Optical Communication Systems,” both which applications are incorporated herein by reference in their entirety. In particular, the possibility of performing polarization-multiplexed WDM transmission on each orthogonally parallel transmission path is contemplated in one embodiment.

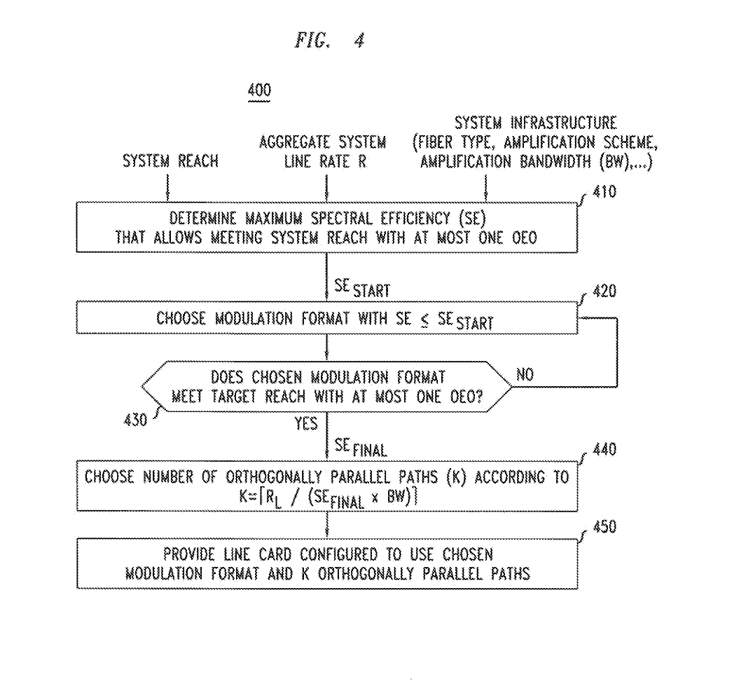

FIG. 4 illustrates a method of scaling optical system throughput according to one embodiment. The method 400 includes determining one or more modulation formats that permit a desired system reach between transmission endpoints utilizing at most a single opto-electronic-opto regeneration between the transmission endpoints 410-440, and providing a line card system as a described above wherein at least one of the plurality of transponders is operable to modulate according at least one of the one or more modulation formats 450.

The method 400 begins at 410 by determining a maximum spectral efficiency (SE) that allows a desired system reach between transmission endpoints utilizing at most a single opto-electronic regeneration. Inputs to the method may include the system reach, the aggregate system line rate R_{L}, and system infrastructure information such as fiber type, amplification scheme, amplification bandwidth (BW) and the like.

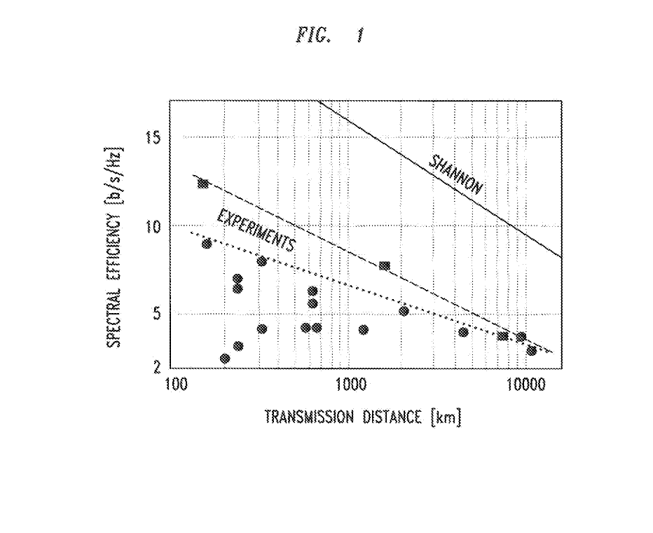

At 420, a first modulation format with first SE less than or approximately equal to the maximum SE is determined. This may involve consulting with a database containing information detailing spectral efficiency and transmission distance achievable for a plurality of WDM and/or narrow-band filtered single channel systems, such as the information detailed in FIG. 1.

At 430, the processor determines whether the first modulation format allows the desired system reach with at most a single opto-electronic regeneration. If the first modulation format does not permit the desired transmission distance with at most a single opto-electronic regeneration, the method loops back to determine another modulation format having a SE that is less than or approximately equal to the maximum SE. The method reviews modulation formats at decreasing SE until it finds a suitable format. When 430 determines that the first modulation format allows the desired transmission distance with at most a single opto-electronic regeneration, the method records the converged upon modulation format and its spectral efficiency ‘SE_{final}’ and proceeds to 440.

At 440, a number of orthogonally parallel paths to be employed by a line card system utilizing the first modulation format is determined. The number of orthogonally parallel paths may be based on the system reach, the desired aggregate system capacity, and an amplification bandwidth of the line card system. System reach and aggregate system capacity are in turn utilized, as described above, to determine a first modulation format to utilize for the system, the first modulation format having a SE. For example, the number of orthogonally parallel paths (K) may be calculated as the aggregate system line rate R_{L} divided by the product of the spectral efficiency of the first modulation format and the amplification bandwidth of the system infrastructure, with the result of the division being rounded up (i.e., K=┌R_{L}/(SE_{final}×BW)┐.

The above methodology may be substantially represented in a computer readable medium and so executed by a computer or processor. For example, a network design optimization computer may perform the above methodology to arrive at a first modulation format and number of orthogonally parallel paths (K) to be employed by a line card. A line card system employing the first modulation format and K orthogonally parallel paths is able to transmit a desired transmission distance received information of an aggregate information rate R_{C} via a plurality of transponders having an aggregate information rate R_{L} less than or equal to R_{C} with at most a single opto-electronic regeneration between transmission endpoints. In this manner, the throughput of an optical system can be scaled in an energy and cost efficient manner, as opposed to the common practice of scaling capacity by increasing SE at the cost of reach, which inherently cannot scale.

At 450, a line card system as a described above wherein ones of the plurality of transponders are operable to modulate according at least the first modulation format and configure to utilize the determined number of orthogonally parallel paths is constructed and/or provided for the scaled optical system.

While this subject matter has been described with reference to illustrative embodiments, this description is not intended to be construed in a limiting sense.

Embodiments may be implemented as circuit-based processes, including possible implementation on a single integrated circuit.

Unless explicitly stated otherwise, each numerical value and range should be interpreted as being approximate as if the word “approximately” preceded the value of the value or range.

It will be further understood that various changes in the details, materials, and arrangements of the parts which have been described and illustrated in order to explain the nature of this subject matter may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the following method claims, if any, recite steps in a particular sequence with corresponding labeling, unless the claim recitations otherwise imply a particular sequence for implementing some or all of those steps, those steps are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor/s to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors”, “controllers” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “module” should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. An optical line card system comprising:
one or more input interfaces for receiving information, the one or more input interfaces having an aggregate information rate Rc;
a line interface comprising a plurality of line transponders; and
a multiplexer for multiplexing output of the one or more input interfaces onto the plurality of line transponders, the plurality of line transponders having an aggregate information rate R_{L} that is less than or approximately equal to the aggregate information rate R_{C} of the one or more of client interfaces;
wherein each of the line transponders employs a modulation format with a spectral efficiency that enables transmission with at most one opto-electronic regeneration point per link to an end point for electronic routing or switching; and
wherein each of the plurality of line transponders is configured to insert output on a respective one of a plurality of orthogonally parallel transmission paths.

2. The optical line card system of claim 1 wherein the plurality of orthogonally parallel transmission paths are spatially orthogonal.

3. The optical line card system of claim 1 wherein the plurality of orthogonally parallel transmission paths are spatially separated fiber strands, cores of a multi-core fiber, or modes of a multi-mode fiber.

4. The optical line card system of claim 1 wherein the plurality of orthogonally parallel transmission paths are orthogonal by wavelength or amplification band.

5. The optical line card system of claim 1 wherein the plurality of line transponders are configured to transmit on a first wavelength set of one or more wavelengths.

6. The optical line card system of claim 1 wherein the plurality of line transponders are integrated.

7. An optical line system comprising:
a first line card system according to the line card system of claim 1; and
an optical link having the plurality of orthogonally parallel transmission paths, the first line card connected to the optical link, the optical link for connection to an end point for electronic routing or switching, the optical link including at most one opto-electronic regeneration point.

8. The optical line system of claim 7 further comprising:
a second line card system according to the line card system of claim 1;
wherein the first line card system is configured to transmit on a first wavelength set having one or more wavelengths; and
wherein the second line card system is configured to transmit on a second wavelength set having one or more wavelengths, the one or more wavelengths of the second wavelength set differing from the one or more wavelengths of the first wavelength.

9. The optical line system of claim 7 further comprising:
an end point for electronic routing or switching, a router, a switch, or a receiver.

10. The optical line system of claim 7 wherein the plurality of orthogonally parallel transmission paths are spatially orthogonal, orthogonal by wavelength, or orthogonal by amplification band.

11. The optical line system of claim 7 wherein the plurality of orthogonally parallel transmission paths are spatially separated fiber strands, cores of a multi-core fiber, modes of a multi-mode fiber, or optical amplification bands.

12. A method comprising:
multiplexing by a first line card system first input from a first set of one or more input interfaces onto a first plurality of line transponders, the input having an first aggregate rate R_{C1};
modulating by the first plurality of line transponders the first input to generate first modulated information, the modulating of the first plurality of line transponders utilizing a first modulation format with a spectral efficiency that enables transmission with at most one opto-electronic regeneration point per link to a corresponding end point for electronic routing or switching; and
outputting the first modulated information from the first plurality of line transponders to a first plurality of orthogonally parallel transmission paths, the first modulated information that is output having a first aggregate rate R_{L1}, wherein the first aggregate rate R_{C1} is less than or approximately equal to the first aggregate rate R_{L1}.

13. The method of claim 12 further comprising:
regenerating the first modulated information at a single opto-electronic regeneration point between at least one of the first plurality of line transponders and the corresponding end point.

14. The method of claim 12 further comprising:
providing the first modulated information to the corresponding end point without regeneration of the first modulated information.

15. The method of claim 12 wherein each of the first plurality of line transponders modulates the first input onto a first wavelength set of at least one first wavelength.

16. The method of claim 12 wherein the plurality of orthogonally parallel transmission paths are spatially orthogonal, orthogonal by wavelength, or orthogonal by amplification band.

17. The method of claim 12 wherein the plurality of orthogonally parallel transmission paths are spatially separated fiber strands, cores of a multi-core fiber, modes of a multi-mode fiber, or optical amplification bands.

18. The method of claim 12 further comprising
multiplexing by a second line card system second input from a second set of one or more client interfaces onto a second plurality of line transponders, the second input having an second aggregate rate R_{C2};
modulating by the second plurality of line transponders the second input to generate second modulated information, the modulating of the second plurality of line transponders utilizing a second modulation format with a spectral efficiency that enables transmission with at most one opto-electronic regeneration point per link to a corresponding receiver; and
outputting the second modulated information from the second plurality of line transponders to a second plurality of orthogonally parallel transmission paths, the second modulated information output having a second aggregate rate R_{L2}, wherein the second aggregate rate R_{C2} is less than or approximately equal to the second aggregate rate R_{L2};
wherein the second modulated information is on a second wavelength set of at least one second wavelength, wherein the first modulated information is on a first wavelength set of at least one first wavelength, the at least one first wavelengths differing from the at least one second wavelengths.

19. A method of scaling optical system throughput, the method comprising:
determining one or more modulation formats that permit a desired system reach at a desired aggregate system capacity between transmission endpoints utilizing at most a single opto-electronic regeneration between the transmission endpoints; and
providing a line card system as claimed in claim 1 wherein at least one of the plurality of transponders is configured to modulate according at least one of the one or more modulation formats.

20. The method of claim 19 wherein determining one or more modulation formats that permit a desired system reach at a desired aggregate system capacity between transmission endpoints utilizing at most a single opto-electronic regeneration between the transmission endpoints comprises:
determining a maximum spectral efficiency (SE) that allows the desired transmission distance at the desired aggregate system capacity between transmission endpoints utilizing at most a single opto-electronic regeneration;
determining a first modulation format with first SE less than or approximately equal to the maximum SE;
determining whether the first modulation format allows the desired system reach with at most a single opto-electronic regeneration; and
when the first modulation format allows the desired transmission distance with at most a single opto-electronic regeneration, determining a number of orthogonally parallel paths to be employed by the line card.

21. The method of claim 20 wherein the number of orthogonally parallel paths is based on the desired system reach, the desired aggregate system capacity, and an amplification bandwidth.
